(19) United States
(12) Patent Application Publication
(10) Pub. No.: US 2015/0284265 A1
(43) Pub. Date: Oct. 8, 2015

(54) ULTRAVIOLET FLUID TREATMENT SYSTEM

(71) Applicants: Kishor Ramdas Borkar, Pune (IN); Kumar Chandrakant Thorat, Hadapsar (IN); Santosh Dadasaheb Pachpund, Kharadi (IN); Christopher S. Rau, Battle Creek, MI (US)

(72) Inventors: Kishor Ramdas Borkar, Pune (IN); Kumar Chandrakant Thorat, Hadapsar (IN); Santosh Dadasaheb Pachpund, Kharadi (IN); Christopher S. Rau, Battle Creek, MI (US)

(73) Assignee: EATON CORPORATION, Cleveland, OH (US)

(21) Appl. No.: 14/243,987

(22) Filed: Apr. 3, 2014

(51) Int. Cl. C02F 1/32

(52) U.S. Cl. CPC C02F 1/325; C02F 2201/322; C02F 2303/04

(57) ABSTRACT

A reactor for UV sterilization having an array of UV-C tubes in a pressure vessel with an inlet at one end of the tubes and an outlet at the opposite end. An orifice plate baffle is disposed between the inlet and the proximate end of the UV tubes. Diffusers may be disposed about the UV tubes in the form of lobed rods or a strip having helically spiraled or twisted surfaces.

### BACKGROUND

In the purification of liquids such as drinking water, waste water, ship ballast water and liquefied fruit pulp, it has been found effective for disinfection of microorganisms or sterilization to employ ultraviolet irradiation to render the microorganisms inactive and sterilize the liquid. In particular, it has been found effective to inactivate or sterilize microorganisms in ship ballast water before the water is introduced into or discharged from the ship's ballast tanks.

In marine vessel water ballast tank applications, water entering or being discharged from the ship's ballast tanks is pumped through a reactor vessel containing ultraviolet irradiation tubes; and, as the sea water is passed over the irradiating tubes, the sea water is to receive a desired dosage of irradiation as it flows past the irradiation tubes. However, it has been found that flow in the reactor about the tubes is not uniform and the desired dosage of irradiation has not been achieved uniformly.

Dosage is improved by bringing flow streamlines closer to the irradiation source, and by maximizing exposure time. Mixing of the flow streamlines can have a beneficial effect on both parameters. Therefore, it has been desired to provide a way or means of maintaining a uniform desired dosage of irradiation to a liquid, such as sea water, flowing through the reactor, either entering or discharging from the ship's ballast tanks.

### BRIEF DESCRIPTION

The present disclosure describes and illustrates a fluid pressure vessel defining a reactor chamber having ultraviolet irradiation tubes in the chamber for providing a dosage of short wavelength ultraviolet irradiation (UV-C) to fluid flowing through the vessel for inactivating or sterilizing microorganisms in the fluid; and, in particular, the reactor is useful for inactivating microorganisms in sea water entering in or discharging from onboard marine vessel ballast tanks. A pressure vessel reactor is described as defining a chamber having an inlet which permits incoming liquid to flow through a baffle in the form of an orifice plate extending as a bulkhead in the pressure vessel. Flow through the orifices in the plate then passes into the portion of the reactor in which the UV-C ultraviolet tubes are disposed. Additionally, a plurality of rods having diffuser surfaces thereon may be disposed about the ultraviolet tubes to direct the fluid flowing over the lobes toward the ultraviolet tubes for aiding in increasing the uniformity of flow and the dosage of the ultraviolet irradiation on the microorganisms in the sea water to maintain the dosage at a desired level. In one version, the diffuser surfaces may comprise spaced lobes; and, in another version, the diffuser surfaces may comprise twisted or helically spiraled surfaces.

### BRIEF DESCRIPTION OF THE DRAWINGS

FIG. 1 is a cut away perspective view of a UV irradiation reactor of the present disclosure;

FIG. 2 is an exploded view of the UV tube cage sub-assembly of the reactor of FIG. 1;

FIG. 3 is an enlarged view of a portion of FIG. 1;

FIG. 4 is an enlarged view of one end portion of the tube cage sub-assembly of FIG. 2;

FIG. 5 is a cross-section of another version of the reactor of FIG. 1 employing additional diffuser rods;

FIG. 6 is another version of diffusers employing helically spiraled surfaces;

FIG. 7 is a CFD simulation plotting percentage of particles dosed as a function of dosage; and,

FIG. 8 is a CFD simulation plotting percentage of particles dosed as a function of residence time.

### DETAILED DESCRIPTION

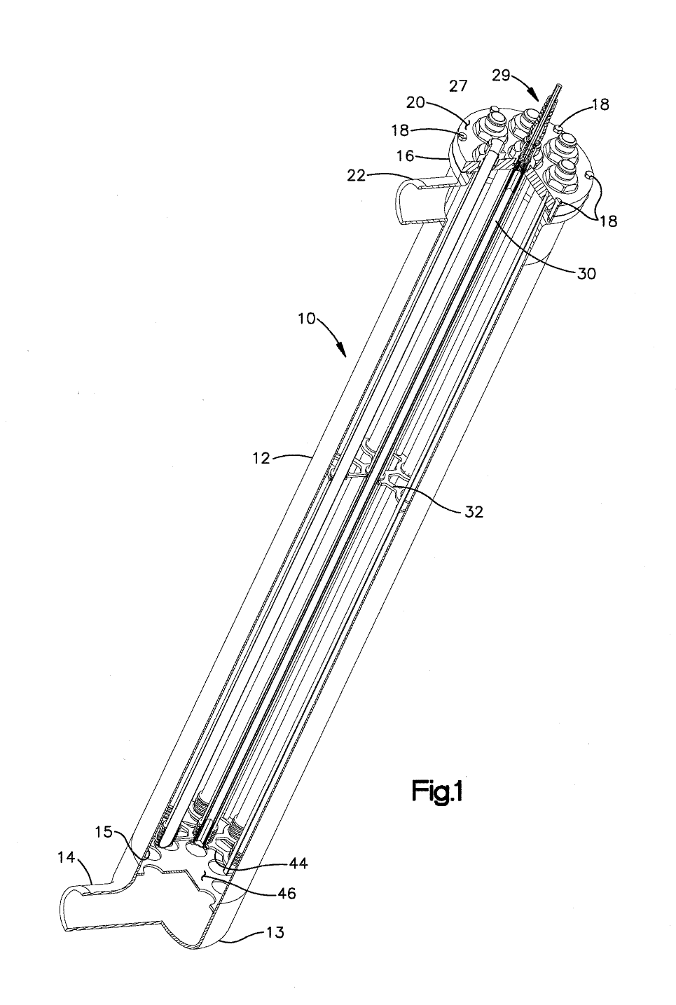

Referring to FIGS. 1-3, a liquid sterilization reactor of the present disclosure is indicated generally at 10 and includes a pressure vessel 12 having a generally cylindrical wall configuration with an end 13 thereof closed and having an inlet fitting 14 provided thereon, the pressure vessel defining a reaction chamber 15 therein. The upper end of the vessel 12 has an annular flange 16 formed thereabout upon which is fastened thereto, such as by bolts 18, a closure or cap 20. An outlet fitting 22 is provided in the pressure vessel 12 adjacent the cap 20.

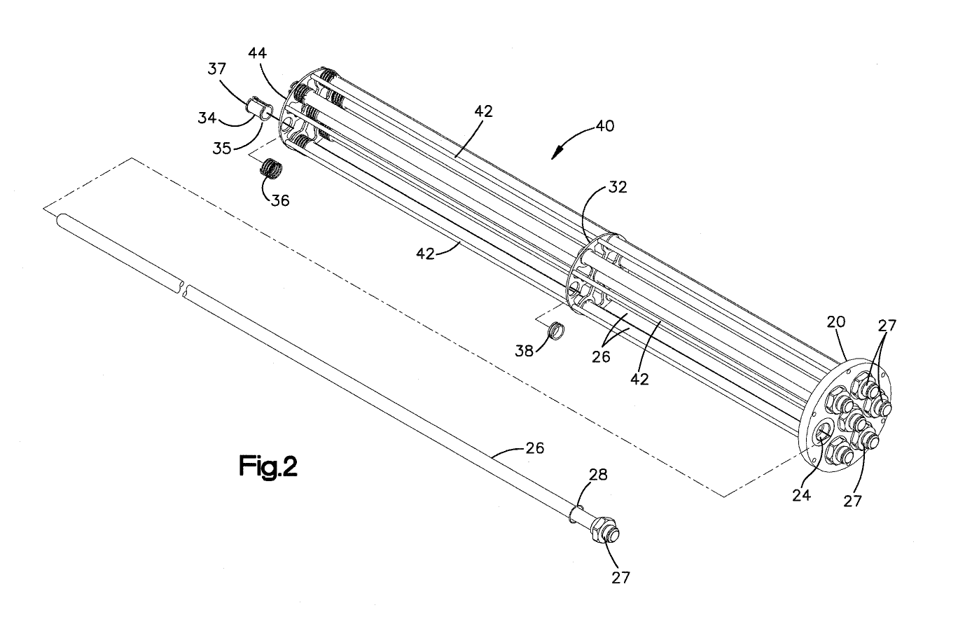

Referring particularly to FIG. 2, the cap or closure 20 is in the form of a circular plate having a plurality of apertures 24 disposed thereabout in a spaced array with each of the apertures 24 having received therein a UV irradiating element 30, shown in FIG. 1, disposed in a quartz tube 26. One end 27 of the quartz tubes extends outwardly through the closure 20 and is sealed about the aperture 24 by a suitable seal ring 28. The quartz tubes 26 each have an electrical connection indicated generally at 29, as shown in FIG. 1, provided through the end thereof for connecting to the respective UV irradiating tube 30 to an unshown source of electrical power.

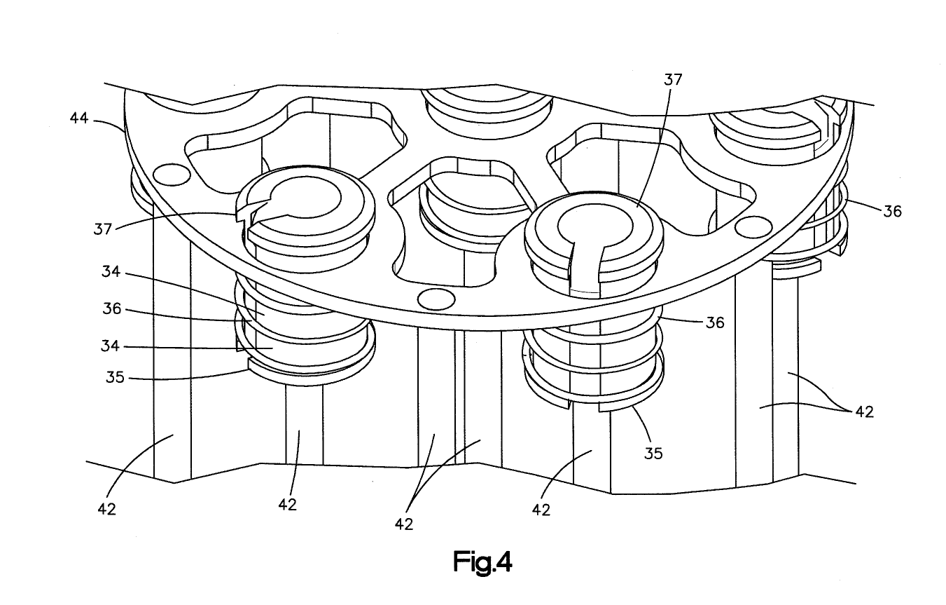

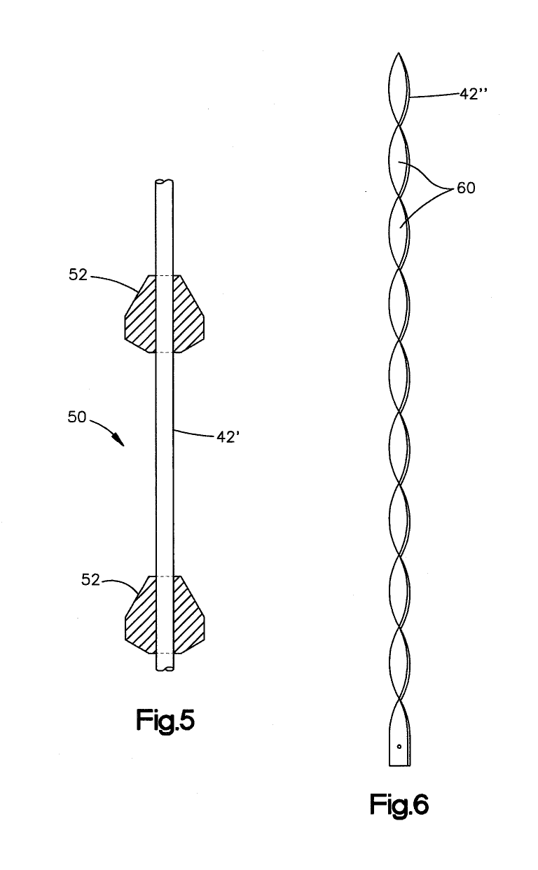

Referring again to FIG. 2, a spacer plate is provided intermediate the ends of the quartz tubes 26 as denoted by reference numeral 32; and, an endplate is received over the remote end of the tubes 26 and retained thereon by a retaining sleeve 34 and compression spring 36. Referring to FIGS. 2 and 4, one end of spring 36 bears against a flange 35, shown in FIG. 4, provided on the sleeve 34 with a flange 37 at the opposite end of sleeve 34 bearing against end plate 44. A support bushing 38 is provided through the apertures in the spacer plate 32; and the spacer plate 32 supports the tubes 26 through the bushing 38. The tube cage sub-assembly indicated generally at 40 in FIG. 2 is received in the open end of the pressure vessel 12 and the cover or closure 20 is bolted onto the flange 16 to secure the assembly in the pressure vessel. In the present practice, a seal, such as an unshown O-ring is provided between flange 16 and cap 20.

With continued reference to FIG. 2, a plurality of supporting rods 42 are provided about the tubes 26 and extend through apertures in the spacer 32, through apertures provided in the cover 20 and apertures in the end plate 34 to maintain the configuration of the tube cage sub-assembly 40. The rods 42 support the spacer 32 and end plate 44 on the closure 20 to relieve mechanical loading on the quartz tubes 26.

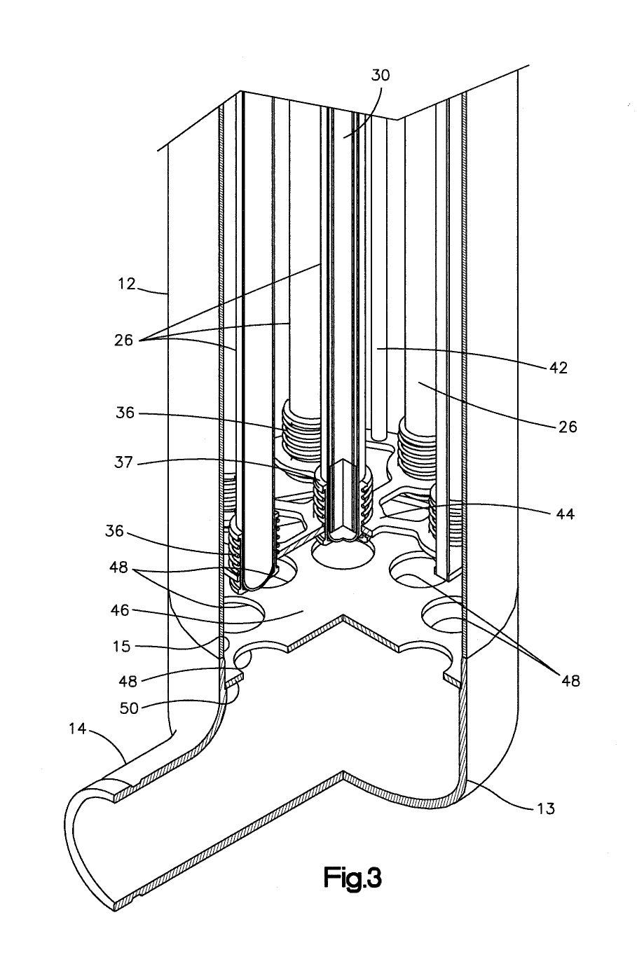

Referring to FIGS. 1 and 3, a baffle 46 is provided between the end plate 44 and the inlet fitting 14 within the treatment chamber 15 formed in the pressure vessel.

The baffle 46 is in the form of a plate having a plurality of orifices therein in a spaced array denoted by reference numeral 48 and serve to baffle flow from the inlet to the quartz tubes 26. In the present practice, the baffle 46 comprises a bulkhead disposed in the pressure vessel and attached thereto such as at a shoulder 50 provided in the interior of the pressure vessel wall as shown in FIG. 3. In the present practice, the reactor assembly 40 comprises 7 quartz tubes; and, the baffle 46 has 8 orifices provided therein. In the present practice, it has been found satisfactory to have the sum of the flow areas of the orifices 48 greater than the flow area of the inlet fitting 14.

In the present practice, the baffle 46 is disposed spaced from the lower ends of the quartz tubes.

Referring to FIG. 4, an enhancement of the reactor of the present disclosure is illustrated generally at 50 wherein the support rods 42′ each have a plurality of annular lobes 52 attached thereto; and, in the present practice, the lobes have a conical configuration as illustrated in FIG. 4. In the present practice, the lobes have a varying diameter in the range of about 1.2 to 1.8 times the diameter of the respective rod 42′. In version 50 of FIG. 4, the lobes 52 tend to deflect and direct the flow towards the quartz tubes 26 to thus increase the dosage of ultraviolet radiation on the microorganisms in the fluid. In the present practice, the UV tubes are of the type emitting ultraviolet-C radiation having a wavelength in the range of 100-280 nanometers (10⁻⁹ meters).

Referring to FIG. 6, another version of the diffuser rods is denoted 42″ and includes an elongated strip member having longitudinally twisted or helically spiraled surfaces 60.

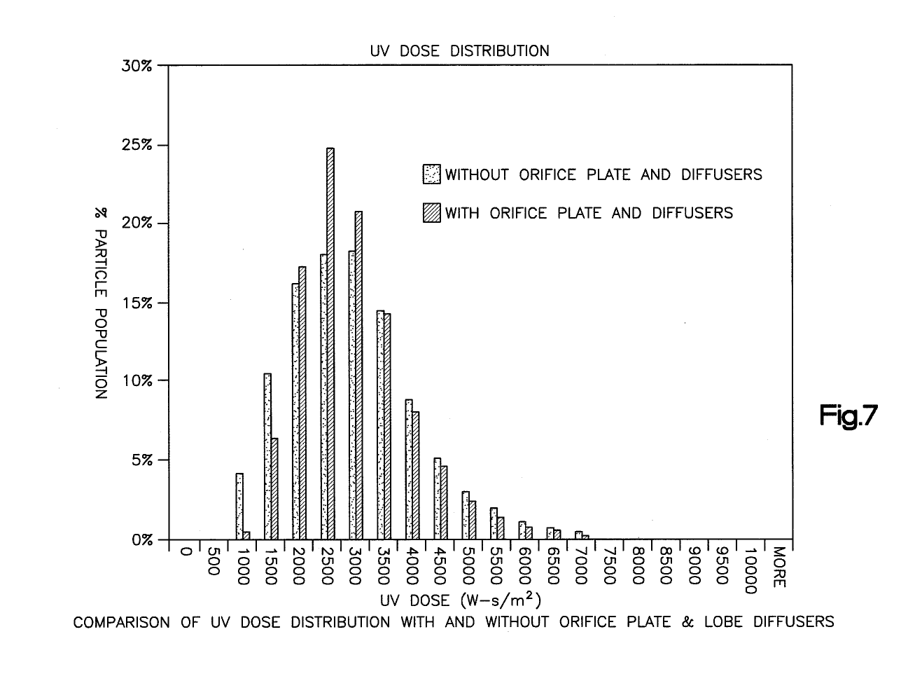

In the present practice, computational fluid dynamics (CFD) was employed to evaluate the UV-C dosage distribution with and without the baffle plate and diffusers; and, the results of the simulation are presented in the histogram of FIG. 6. The darker shaded bars in FIG. 7 indicate the greater number of particles, or percent of particle population, in the liquid given a greater dosage as measured in watt-seconds per square meter (w-s/m²) and in the region of peak dosage, the greater number of particles receives the dosage.

It will be understood that an efficient reactor will have a more concentrated distribution with a smaller population of dosage at both the low or underdose and high or overdose regions. Underdose risks organisms surviving the irradiation process; and, overdosage wastes power with no additional benefit.

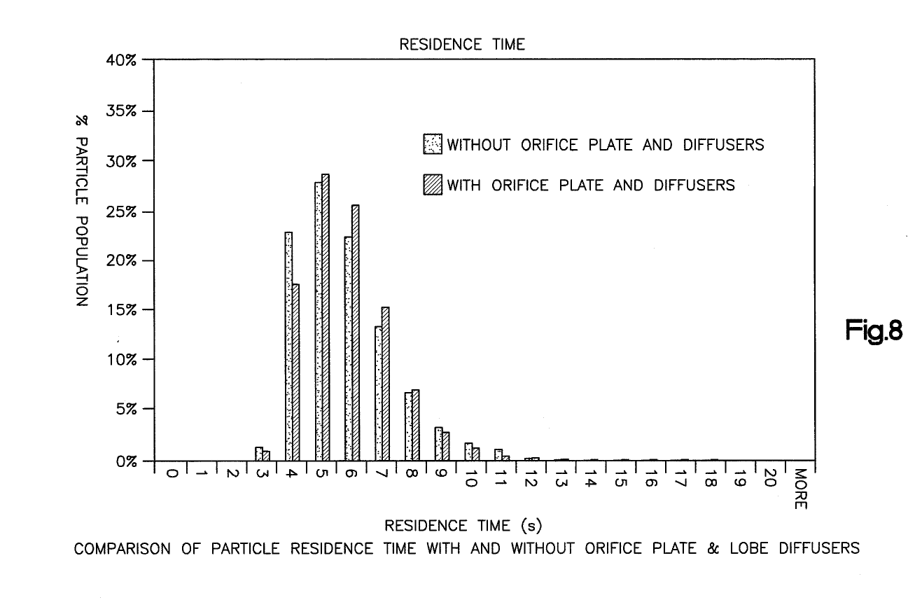

Referring to FIG. 8, a histogram for the CDF is presented plotting the percent of the particle population in the liquid as a function of residence time.

The present disclosure thus describes an ultraviolet radiation reactor for sterilizing liquids flowing through the reactor and utilizes a baffle in the form of an orifice plate disposed between the inlet and the ultraviolet radiating tubes in the reactor. Diffuser lobes may be provided on the rods defining the tube cage assembly for aiding in directing flow toward the radiating tubes to improve the dosage of ultraviolet radiation on the particles in the fluid for effecting the sterilization.

1. A water treatment system comprising:
(a) a pressure vessel having a wall thereof defining therein a treatment chamber having an inlet for receiving untreated water and an outlet for discharging treated water;
(b) a plurality of irradiation tubes disposed in an array in the treatment chamber; and,
(c) a flow directing baffle disposed in the treatment chamber and positioned intermediate the inlet and the array of irradiation tubes.

2. The system of claim 1, further comprising a plurality of flow diffuser members disposed about the irradiating tubes and operable to deflect flow toward the irradiating tubes for maintaining the radiation dosage at a desired level.

3. The system of claim 2, wherein the diffuser members comprise a plurality of elongated rods disposed in spaced parallel arrangement in an annular array about the irradiating tubes.

4. The system of claim 2, wherein the flow diffuser members comprise rods with spaced lobes thereon.

5. The system of claim 4, wherein the lobes have a conical configuration.

6. The system of claim 4, wherein the lobes have a varying diameter of in the range of about 1.2 to 1.8 times the diameter of the respective rod.

7. The system of claim 2, wherein the diffuser members include twisted or helically spiraled surfaces.

8. The system of claim 1, wherein the irradiating tubes are operable to emit ultraviolet-C radiation having a wavelength in the range of 100-280×10⁻⁹ meters.

9. The system of claim 1, wherein the flow directing baffle comprises a plate having an array of orifices.

10. The system of claim 1, wherein the flow directing baffle comprises a bulkhead in the pressure vessel.

11. The system of claim 1, wherein the baffle includes eight orifices for a system employing seven irradiating tubes.

12. The system of claim 1, wherein the sum of the flow areas of the orifices is greater than the flow area of the inlet.
